(19) United States
(12) Patent Application Publication
(10) Pub. No.: US 2026/0059287 A1
(43) Pub. Date: Feb. 26, 2026

(54) SERVICE CONTINUITY ASSOCIATED WITH INTER PINE COMMUNICATION CHANGES FROM DIRECT MODE TO USING INTERMEDIATE PEGC

(71) Applicant: InterDigital Patent Holdings, Inc., Wilmington, DE (US)

(72) Inventors: Debashish Purkayastha, Eagleville, PA (US); Shalini Choudhury, Highland Park, NJ (US); Robert Gazda, Spring City, PA (US); Michael Starsinic, Newtown, PA (US); Anuj Sethi, Ottawa (CA); Taimoor Abbas, Sainte-Julie (CA); Saad Ahmad, Montreal (CA)

(73) Assignee: InterDigital Patent Holdings, Inc., Wilmington, DE (US)

(21) Appl. No.: 19/102,523

(22) PCT Filed: Aug. 10, 2023
(86) PCT No.: PCT/US2023/029985

§ 371 Date: Feb. 10, 2025

Related U.S. Application Data
(60) Provisional application No. 63/396,755, filed on Aug. 10, 2022.

(51) Int. Cl. H04W 8/00; H04W 8/22; H04W 84/10

(52) U.S. Cl. CPC H04W 8/005; H04W 8/22; H04W 84/10

(57) ABSTRACT

Systems and methods are described herein for service continuity. Service continuity may be performed and/or provided, for example, if (e.g., when) inter wireless transmit/receive unit (WTRU) communication changes from a direct mode to using an intermediate gateway capable WTRU. A personal Internet of Things network (PIN) may be used. WTRUs may be part of the PIN. WTRUs in the PIN may be referred to as a PIN element (PINE). WTRUs and/or PINEs in the PIN may be associated with different capabilities. For example, a PINE in a PIN may be a PINE with gateway capability (PEGC). For example, a PINE in a PIN may be a PINE with management capability (PEMC).

### CROSS-REFERENCE TO RELATED APPLICATIONS

The application claims the benefit of U.S. Provisional Application 63/396,755, filed Aug. 10, 2022, the contents of which are incorporated by reference in their entirety herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems and methods are described herein for service continuity. Service continuity may be performed and/or provided, for example, if (e.g., when) inter wireless transmit/receive unit (WTRU) communication changes from a direct mode to using an intermediate gateway capable WTRU. A personal Internet of Things network (PIN) may be used. WTRUs may be part of the PIN. WTRUs in the PIN may be referred to as a PIN element (PINE). WTRUs and/or PINEs in the PIN may be associated with different capabilities. For example, a PINE in a PIN may be a PINE with gateway capability (PEGC). For example, a PINE in a PIN may be a PINE with management capability (PEMC).

In examples, a PINE (e.g., WTRU) may subscribe for service continuity to a PEMC. The PEMC may authorize a PIN service and obtain a context token (e.g., which may store the session context, for example, associated with the service). The PEMC may trigger PEGC selection in the PINE, for example, by a message (e.g., application layer message). The PEMC may configure selected PEGCs for service continuity (e.g., for the PINE to use for service continuity). The PEMC may configure the PINEs to connect to the selected PEGC for service continuity.

A WTRU may configure service continuity between entities. The WTRU may be a PEMC. A WTRU may receive a notification message. The notification message may indicate a loss of service continuity between a first PINE and a second PINE. The notification message may indicate a PINE ID and a session ID. The WTRU may send a discovery request message to the first PINE and the second PINE. The discovery message may indicate PEGC discovery. The WTRU may receive a discovery response message. The discovery response message may indicate first PEGC discovery information (e.g., from the first PINE) and second PEGC discovery information (e.g., from the second PINE). The WTRU may determine a PEGC based on the first and second PEGC discovery information. The WTRU may send a selection message to the determined PEGC for service continuity between the first PINE and the second PINE. The selection message may indicate the first PINE ID associated with the first PINE and the second PINE ID associated with the second PINE. The selection message may indicate a context token. The WTRU may receive a confirmation message from the determined PEGC indicating that service continuity between the first PINE and the second PINE is configured. The confirmation message may indicate a PEGC internet protocol (IP) address. The WTRU may send a configuration message to the first PINE and the second PINE, for example, indicating the service continuity configuration information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a home automation personal Internet of Things network (PIN).

FIG. 3 illustrates an example wearable PIN.

FIG. 4 illustrates an example PIN architecture.

FIG. 5 illustrates an example a PIN Application architecture.

FIG. 6 illustrates an example service continuity through a PEGC.

FIG. 7 illustrates an example of service continuity through two or more PEGCs.

FIG. 8 illustrates an example procedure for service continuity, ALT1.

FIG. 9 illustrates an example procedure for service continuity.

FIG. 10 illustrates an example procedure for service continuity.

### DETAILED DESCRIPTION

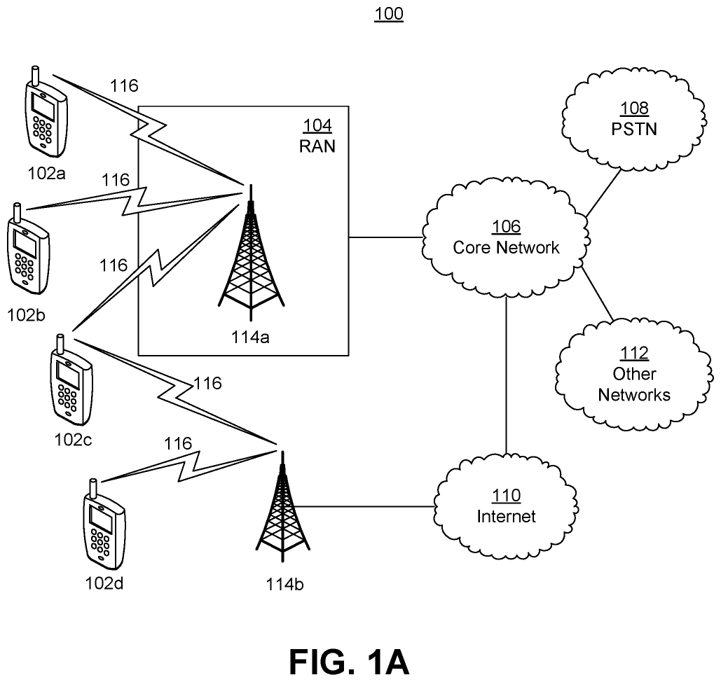

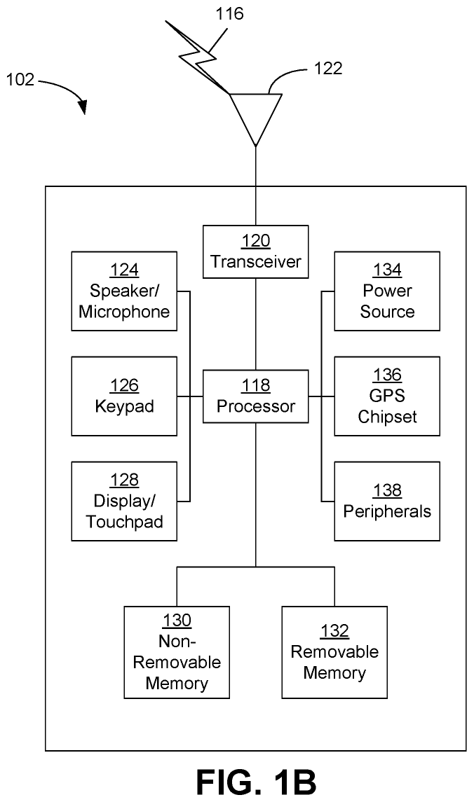

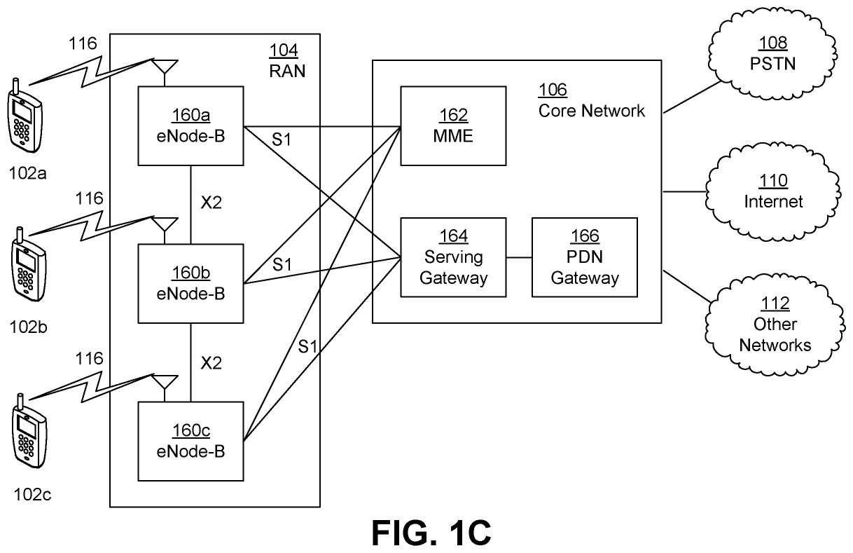

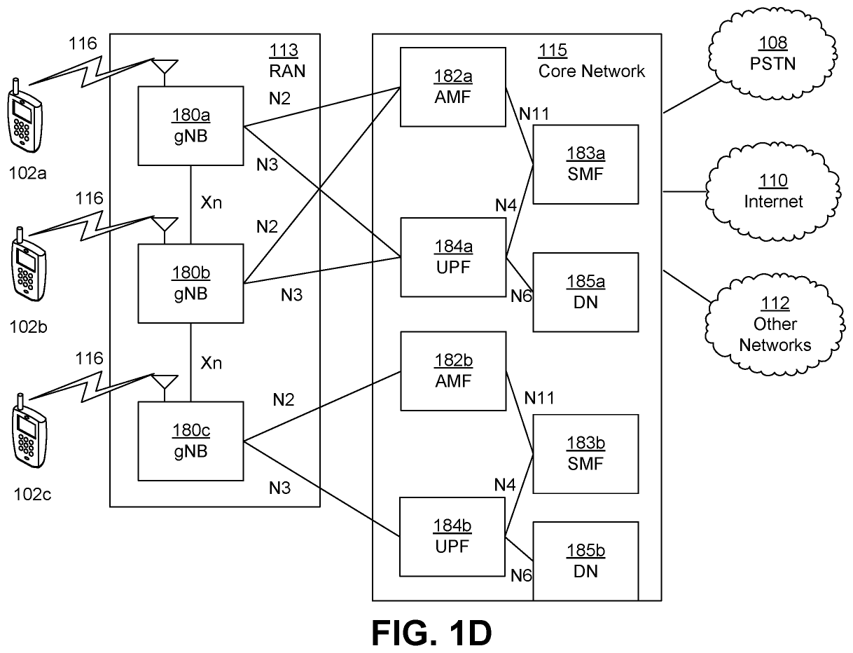

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods are described herein for service continuity. Service continuity may be performed and/or provided, for example, if (e.g., when) inter wireless transmit/receive unit (WTRU) communication changes from a direct mode, for example, to using an intermediate gateway capable WTRU. A personal Internet of Things network (PIN) may be used. WTRUs may be part of the PIN. WTRUs in the PIN may be referred to as a PIN element (PINE). WTRUs and/or PINEs in the PIN may be associated with different capabilities. For example, a PINE in a PIN may be a PINE with gateway capability (PEGC). For example, a PINE in a PIN may be a PINE with management capability (PEMC).

In examples, a PINE (e.g., WTRU) may subscribe for service continuity to a PEMC. The PEMC may authorize a PIN service and obtain a context token (e.g., which may store the session context, for example, associated with the service). The PEMC may trigger PEGC selection in the PINE, for example, by a message (e.g., application layer message). The PEMC may configure selected PEGCs for service continuity (e.g., for the PINE to use for service continuity). The PEMC may configure the PINEs to connect to the selected PEGC for service continuity.

A WTRU may configure service continuity between entities. The WTRU may be a PEMC. A WTRU may receive a notification message. The notification message may indicate a loss of service continuity between a first PINE and a second PINE. The notification message may indicate a PINE ID and a session ID. The WTRU may send a discovery request message to the first PINE and the second PINE. The discovery message may indicate PEGC discovery. The WTRU may receive a discovery response message. The discovery response message may indicate first PEGC discovery information (e.g., from the first PINE) and second PEGC discovery information (e.g., from the second PINE). The WTRU may determine a PEGC based on the first and second PEGC discovery information. The WTRU may send a selection message to the determined PEGC for service continuity between the first PINE and the second PINE. The selection message may indicate the first PINE ID associated with the first PINE and the second PINE ID associated with the second PINE. The selection message may indicate a context token. The WTRU may receive a confirmation message from the determined PEGC indicating that service continuity between the first PINE and the second PINE is configured. The confirmation message may indicate a PEGC internet protocol (IP) address. The WTRU may send a configuration message to the first PINE and the second PINE, for example, indicating the service continuity configuration information.

Personal Internet of Things network(s) may be provided and/or used.

The Internet of Things (IoT) feature may be used by devices that communicate using the (e.g., traditional) cellular network. Devices with IoT capabilities may use (e.g., require) better power consuming performance (e.g., compared to power consuming performance for devices without IoT capabilities) and may increase the network efficiency for bulk operations.

The WTRUs with IoT capabilities may be organized in a Personal IoT Network (PIN), for example, if (e.g., when) multiple IoT devices are deployed in an environment (e.g., private environment). For example, in a home environment, a security sensor, smart light, smart plug, printer, cellphone may be managed (e.g., by a residential gateway) and may communicate with each other. In this case, (e.g., all) devices in a home may constitute a Personal IoT Network (PIN). The devices (e.g., each of the devices) may include (e.g., be called) a PIN element and different PIN elements may have different capabilities. For example, a residential gateway can include a PIN Element with Gateway Capability (PEGC), for example, to provide connections between PIN elements and connections between a network and one or more PIN Elements. A PIN Element with Management Capability (PEMC) may be a PIN Element that provides a means for (e.g., enables) configuring and managing a PIN (e.g., an authorized administrator to configure and manage a PIN), e.g., residential gateway which may be acting as a PEGC may support PIN management function as well and be a PIN element with management capability.

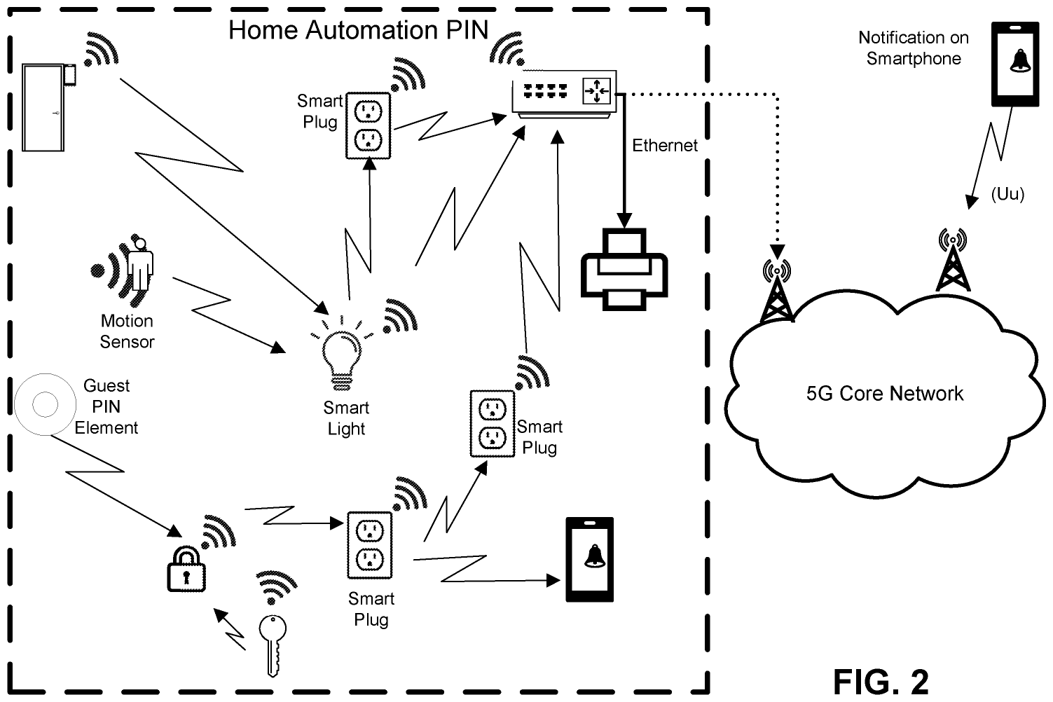

FIG. 2 illustrates an example of a home automation PIN. Wearable devices may constitute another kind of PIN. A smart phone may act as a PIN Element with Gateway Capability (PEGC) as well as a PIN element with management capability (PEMC). A smart watch, VR/AR glass, and/or airpod may communicate with each other in the PIN or with other WTRUs via the network.

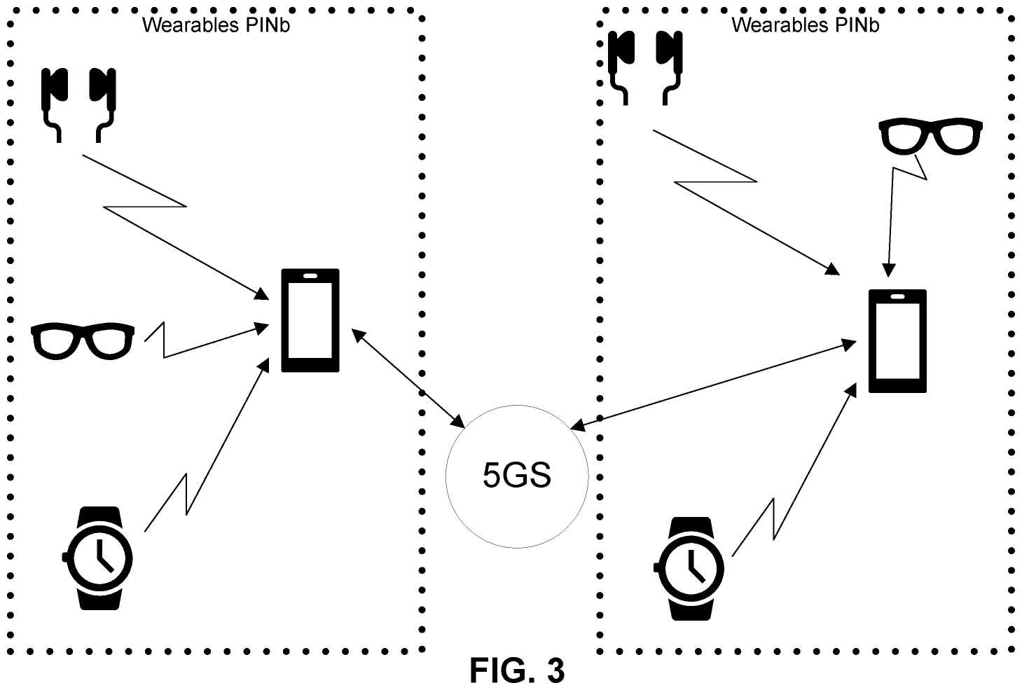

FIG. 3 illustrates an example wearable PIN.

A personal Internet of Things networks architecture may be provided.

A Personal Internet of Things networks (PIN) may include a PIN Element (PE/PINE), PIN Management (PEMC), and a PIN Gateway (PEGW). A PIN element may be a WTRU or device that may communicate within a PIN. A PIN management device may be a PIN Element with capability to manage the PIN. A PEGC may be a PIN Element that may (e.g., have the ability to) provide connectivity to and from the network for other PIN Elements.

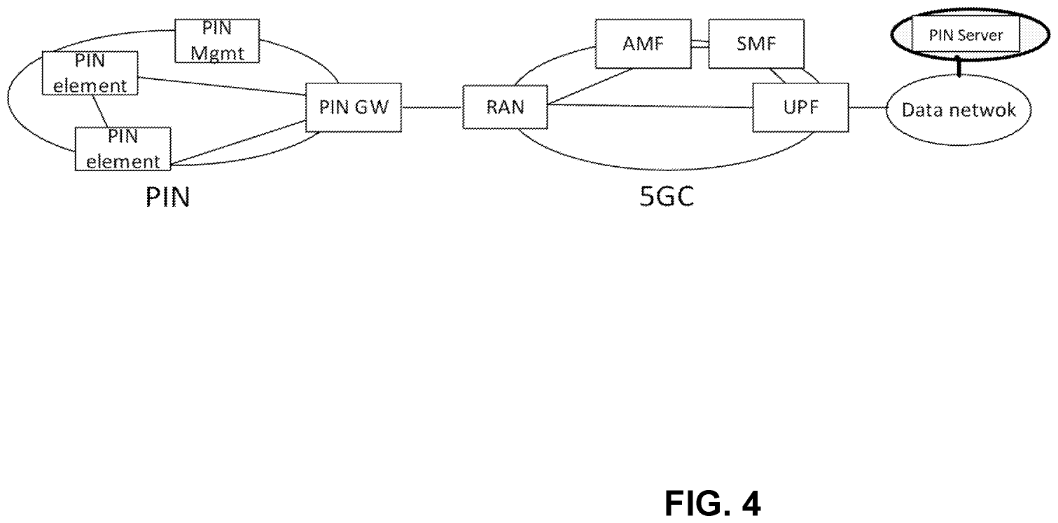

FIG. 4 illustrates an example personal Internet of Things networks architecture.

PIN elements may communicate with each other (e.g., via PEGC or directly). PIN elements may communicate with a system to obtain services or communicate with a data network (e.g., via the core network).

PIN elements with Management capabilities and PIN element with gateway capabilities (e.g., only PIN elements with Management capabilities and PIN element with gateway capabilities) may be a WTRU. Communications (e.g., all other communications) within the PIN may be carried out via communication (e.g., such as WiFi and/or Bluetooth).

A PIN Application Framework (e.g., PINAPP) may be provided and/or used.

Application layer support may be provided and/or enabled for Personal IoT networks (PINs).

Application layer architecture may be designed for PINs (e.g., meeting requirements of PIN). A PIN application layer functional model may be supported.

An application architecture for enabling PINAPP may be provided (e.g., as described herein).

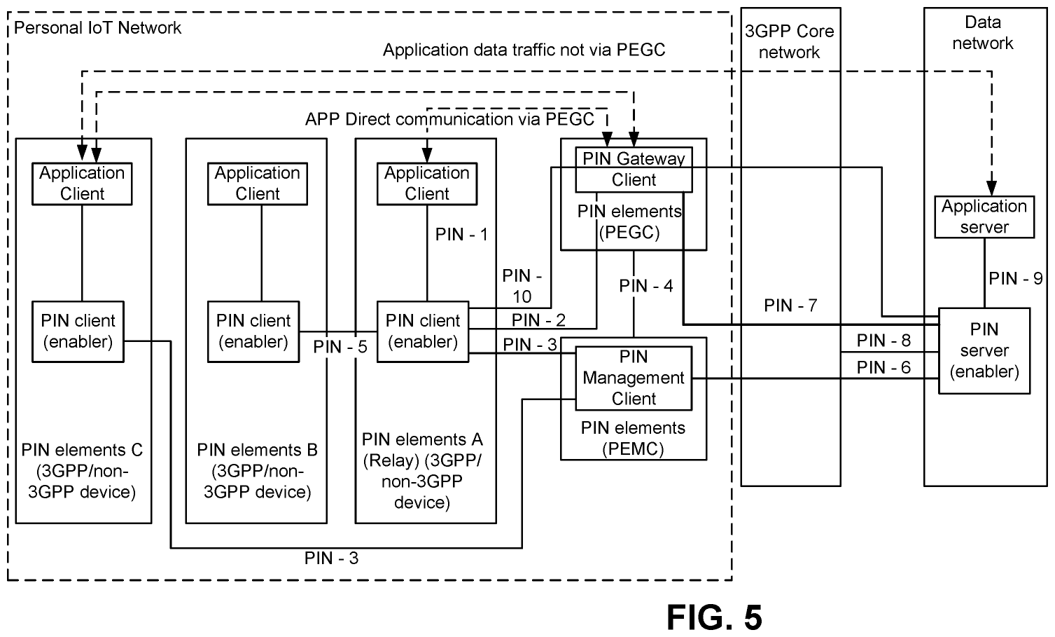

FIG. 5 illustrates an example PINAPP architecture.

Application entities such as a PIN Client in a PINE, a PIN Gateway Client in a PEGC, PIN Management Client in a PEMC, and/or a PIN Server in data network may be a part of the PINAPP architecture and may enable the (e.g., desired) feature in a PIN. These functional entities and the PIN node may be used (e.g., interchangeably), for example, to enable PINAPP feature. A PIN node may assume the PIN functional entities, e.g., PINE may refer to PIN Client, PEMC may refer to PIN Management Client, PEGC may refer to PIN Gateway Client.

Service disruption may be minimized if (e.g., when) a PIN Element changes the communication path, for example, from communication (e.g., direct communication) between the PINEs to the use of an intermediate PEGC. Service disruption may be minimized if (e.g., when) a PIN Element changes the communication path, for example, from communication (e.g., direct communication) between the PINEs to the use of one or more intermediate PEGCs.

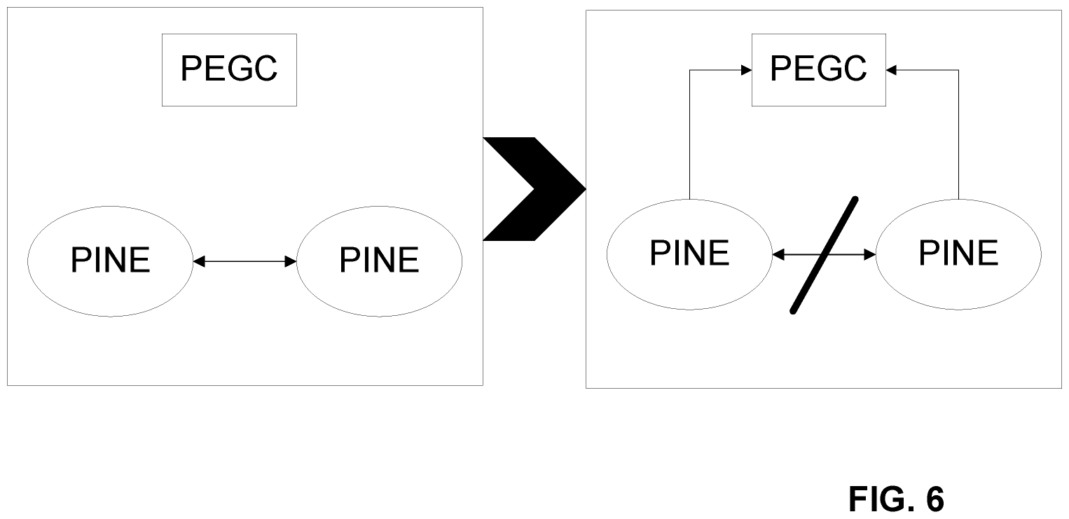

FIG. 6 illustrates an example service continuity through a PEGC.

A PIN may include different PIN elements (e.g., sensors, AR/VR, smart TV etc.) and these PIN elements (PINE) may have different requirements. The PIN Elements may interact with each other directly, for example, without connecting through PEGC.

PINEs may go out of reach of each other, for example, due to mobility of the PINEs. The service between the (e.g., two) PINEs may be interrupted. A suitable PEGC may be discovered, selected and configured to continue the service through it, for example, to enable service continuity.

The discovery and selection of PEGC may be performed.

The (e.g., correct) PEGC discovery and selection procedure may be triggered (e.g., from the application layer). The selected PEGC may be configured for service continuity. An application layer mechanism may be used to configure the selected PEGC for service continuity.

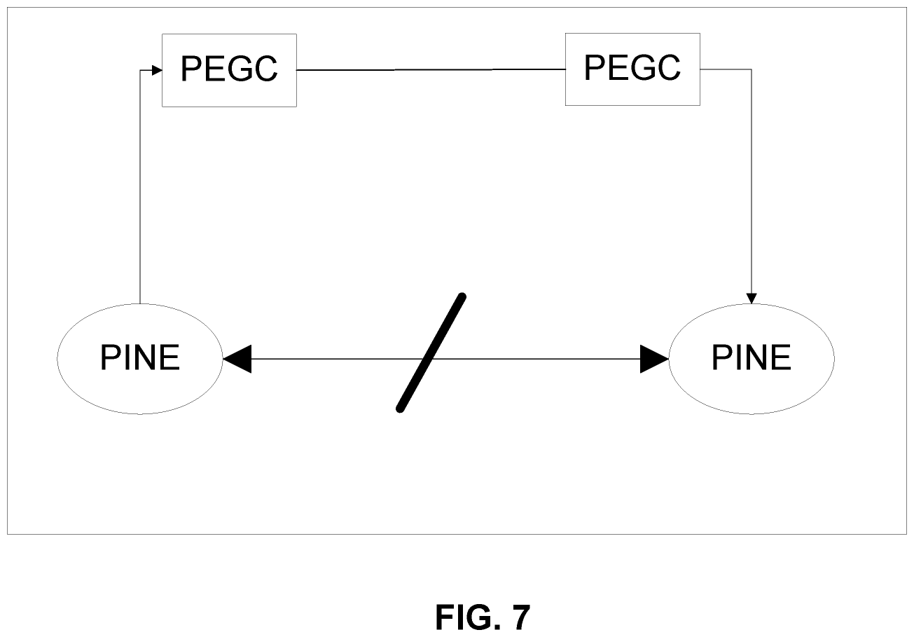

FIG. 7 illustrates an example of service continuity through multiple PEGC.

In examples (e.g., to restore service continuity between two PINEs), a (e.g., more than one) PEGC may be used (e.g., required) depending on the location of the PINEs. In this scenario, multiple PEGCs (e.g., after selection) may be configured (e.g., through the application layer mechanism) to enable service continuity.

A PINE subscription for service continuity may be used and/or enabled.

One or more PINEs interacting among themselves may subscribe to a PEMC for service continuity. A PEMC may authorize the request from the PIN Server. If the subscription is valid, a PEMC may take action to maintain service continuity, for example, if (e.g., when) PINEs lose contact and need service continuity. A Context Token may be used to save the context of the service continuity among PINEs, PEMC, PEGC, and/or a PIN Server.

PEGC discovery may be triggered, for example, by PINE using an application mechanism.

A PINE that may lose contact with another PINE may inform the PEMC about the disruption in service. A PEMC may start a service continuity procedure and may (e.g., decide to) select PEGC, for example, which may provide service continuity. The PEMC may trigger a (e.g., specific) PEGC selection procedure, which may be initiated by PINE. The PEMC may send a message to the PINE, for example, to trigger the PEGC Selection procedure. The PEMC may select one or more PEGC(s) for service continuity, for example, if (e.g., after) PINE reports back the discovered PEGCs to the PEMC.

A PEGC may be configured, for example, using the application mechanism.

The PEMC may send configuration information to the PEGC (e.g., configuring the PEGC) for service continuity with PINE information such as PINE ID, PINE end point identifier, and/or policy related to service continuity for PINE. The PEGC may update forwarding tables and/or allocate resources, for example, based on policy information.

The PEMC may request the system (e.g., 5GS) to provide configuration information to PEGC.

The PEMC client may trigger (e.g., internally) to the PEMC NAS layer to send a request to the system (e.g., 5GS) for PEGC packet forwarding configuration information. A system (e.g., 5GS) may provide forwarding rules to selected PEGCs to enable packet forwarding internally as well as between PEGCs.

A PEMC may configure PINE to enable service continuity through PEGC.

The PEMC may configure the PINE with the PEGC information (e.g., send configuration information indicating PEGC information). The PINE may use the PEG information to connect to the PEGC (e.g., so that the service may be continued through PEGC).

A context token may be used.

To enable the service continuity feature, a Context Token may be used. A context token may be used among the PINAPP application clients to retrieve end point information and/or application context and/or to update the token as end point changes due to service continuity.

An example of the Context Token is illustrated in Table 1.

TABLE 1
Context Token data type

| Attribute name | Data type | Cardinality | | Description |
|---|---|---|---|---|
| tokenId | String | 1 | Required | Identifier for this token |
| pinId | String | 1 | Required | Identifier of the PIN. This attribute |
| | | | | shall be unique across 5GS |
| >pinDescription | Long text | 1 | Required | Human-readable description of the |
| | strings | | | PIN, for example, the company |
| | | | | name, location. or the type of |
| | | | | service. |
| pineId | List | 1 . . . N | Required | Identifier of the PIN element in the |
| | | | | PIN. This attribute shall be unique. |
| >>type | String | | | PINE, PEMC, PEGC-S, PEGC-T |
| >gpsi | String | 1 | Optional | Generic Public Subscription |
| | | | | Identifier for the PIN element. This |
| | | | | attribute is unique and assigned by |
| | | | | the service provider |
| >ipAddress | String | 1 | Required | IP v4 address assigned to network |
| | | | | elements |
| >msisdn | String | 1 | Optional | Identifier for a subscription in a |
| | | | | global system for mobile |
| | | | | communication. This attribute shall |
| | | | | be unique and assigned by network |
| | | | | operator |
| pinePolicy | Long text | 1 | Required | Policy related to service continuity |
| | strings | | | of the PINE such as: |
| | | | | 1. SC will be allowed or not |
| | | | | 2. Allowed QoS during SC |
| | | | | 3. PINE location to avail SC |
| | | | | 4. Time restrictions to avail SC |
| | | | | 5. Network resources reserved for SC |
| applicationServerId | String | 1 | Required | Identifier of the application server. |
| | | | | This attribute may be unique |
| >serviceId | String | 1 | Required | Identifier of the service in the |
| | | | | application server being availed by |
| | | | | the PIN element. This attribute may |
| | | | | be unique |
| sessionId | String | 1 | Optional | |
| applicationContext | Struct | | | |
| >>pkt_marker | String | | | Markers used for identifying |
| | | | | application data packets, especially |
| | | | | for the purpose of starting and |
| | | | | releasing buffers |
| >>app_context | String | | | Set of data that identifies application |
| | | | | context: |
| | | | | Logical state |
| | | | | Tables and data |
| | | | | Counter values |
| | | | | Timer values |

Service Continuity (SC) may be enabled and/or provided through a (e.g., single) PEGC.

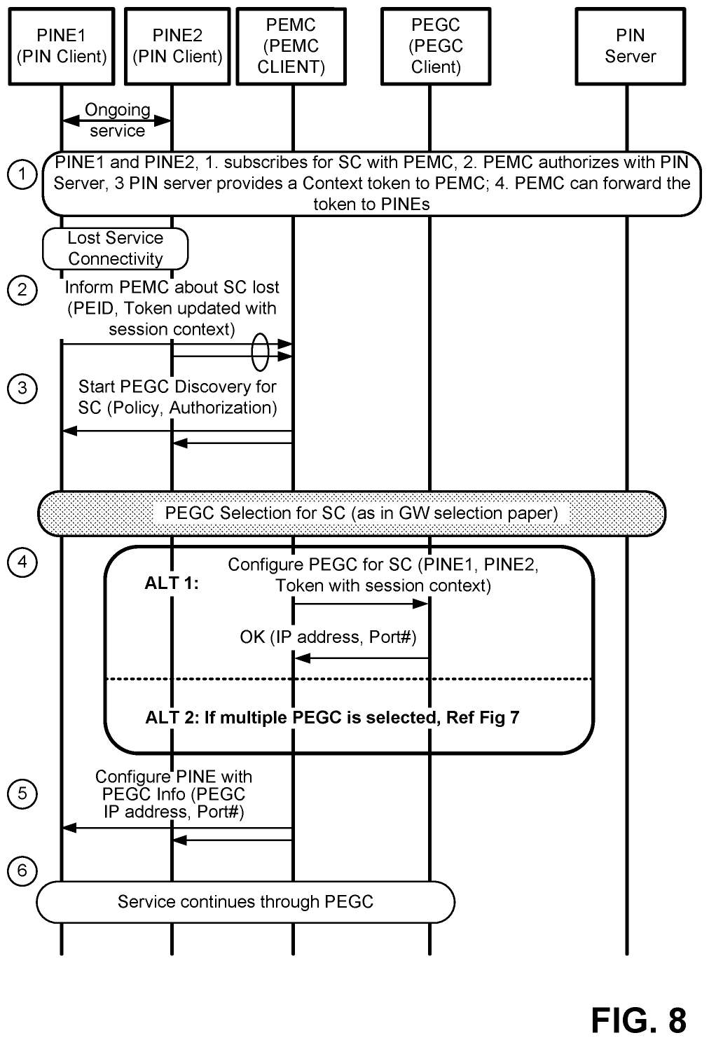

FIG. 8 illustrates an example procedure for service continuity, ALT1.

As shown in FIG. 8 at 810, PINE1 and PINE2 may communicate (e.g., directly) over a (e.g., any kind of) D2D technology (e.g., WiFi, ProSe/PC5, Bluetooth).

The PINEs may perform one or more of the following to enable service continuity.

The PINEs (e.g., the PIN Client) may subscribe to PEMC, for example, to request support for service continuity. The PEMC may create a list of PINEs which requested SC and/or the session for which SC is requested. The PEMC may (e.g., based on the session and PINE ID) determine the PINEs are communicating via a session, which may be a D2D session (e.g., without a gateway), and may use one or more gateways for service continuity (e.g., if the D2D session is lost).

The PEMC may authorize the SC request with PIN Server. The PEMC may send PINE IDs of the (e.g., two) PINEs, the type of service, the existence of connectivity (e.g., direct connectivity) between the PINEs (e.g., D2D session), the session ID, etc.

The PIN Server may authorize the PINEs for service continuity and may create a Context Token. The token may include PINE IDs, Session ID, Session Type, Policy information, etc. The PIN server may respond to PEMC by sending SC authorization information and the context token.

The PEMC may (e.g., optionally) forward the Context Token with authorization information to the PINE so that PINE can use/update the Context Token (e.g., if required).

As shown in FIG. 8 at 820, the PINEs may lose connectivity. It may be assumed that at that point (e.g., the PINEs losing connectivity) the service is discontinued. The PINE may inform PEMC about the service discontinuity, for example, by sending SC Lost with a PINE ID and/or Session ID. The PINE may update the context token with the application context, for example, if (e.g., when) the service was lost. For example, Application Context may contain one or more of the following: the state of the PINE application (e.g., such as Init, startup, game scene1, etc.); data sets when connectivity was lost; counter and time values (e.g., via a timer); last data packet (e.g., data pkt) received; etc. The PINE may send the updated context token to the PEMC.

As shown in FIG. 8 at 830, the PEMC (e.g., PIN Management Client) may save the updated context token and may verify if the PINEs were authorized for SC. The PEMC may retrieve the authorized policy from the context token for the (e.g., each) PINE.

The PEMC (PIN Management Client) may determine that there was a communication, which may be a direct communication, between the devices. The PEMC may determine that a PEGC may (e.g., need to) be selected for service continuity, for example, based on the associated Session ID.

The PEMC may perform (e.g., be capable of performing) various PEGC selection procedures. In this scenario, a PIN Management Client may select a (e.g., specific) PEGC selection procedure, for example, which may involve PEGC discovery by PINE. The PIN Management Client may trigger the discovery procedure by sending a message (e.g., Start PEGC Discovery for SC) to the PIN Client. The message may include policy and authorization information for PINEs to start discovery of PEGC.

The PEGC discovery by PINE may be triggered (e.g., by receiving a message, for example, Start PEGC Discovery for SC). PINEs may report back discovered PEGC information to the PEMC. The PEMC may select a (e.g., optimal) PEGC. The PIN nodes may be involved in PEGC discovery. The PIN Management Client may be (e.g., made) aware of the selected PEGC, for example, based on (e.g., after) completion of discovery procedure. It may be assumed that the PIN Management Client is informed about the selected PEGC's IP address, PEGC ID, and/or associated policy.

In ALT1 (e.g., as shown in FIG. 8), a (e.g., only one) PEGC may be selected by PEMC. As shown in FIG. 8 at 840, the PIN Management Client in PEMC may configure (e.g., start configuring) the selected PEGC for service continuity. The PIN Management Client in PEMC may send a message (e.g., selection message, such as, Configure PEGC for SC message) to the selected PEGC (PIN Gateway Client), which may includes the PINE ID of the (e.g., two) PINEs and the Context Token.

The PIN Gateway client may configure the forwarding table in PEGC so that the PINEs traffic (e.g., related to the service) may be transferred back and forth. The PIN Gateway Client may parse the Context Token to perform one or more of the following: to determine policy related to PINEs and allocate forwarding resources based on the policy; determine if new IP addresses will be assigned or IP address of the PINE is to be restored (e.g., if IP address is to be restored, then the PINE IP address may be retrieved from the Context Token and set properly); to determine application context and set up forwarding path based on application state and application requirement; allocate port numbers (e.g., Port #) for the (e.g., specific) session (e.g., possibly two for the two PINEs); etc.

The PEGC Client may send a confirmation to PEMC (e.g., based on successful configuration), for example, which may include PEGC IP address and port numbers for the PINEs.

As shown in FIG. 8 at 850, the PIN Management Client in PEMC may instruct the PIN Enabler Client in PINE to connect to the selected PEGC, for example, by sending a message (e.g., a Configure PINE with PEGC Info message). The message may include a PEGC ID, a PEGC IP address, a Port #created for PINE service/session.

As shown in FIG. 8 at 860, the PINE (e.g., the PIN Enabler Client) may set up the connection towards the PEGC using PEGC IP address, Port #, etc. The PEGC may use DHCP to assign a different (e.g., new) address if (e.g., when) the PINE connects, for example, depending on the policy for the PINE. Otherwise, the PINEs IP address may be restored for seamless service continuity, for example, if supported by PEGC. The service between PINE1 and PINE2 may continue, for example, based on (e.g., after) successful setup.

Service Continuity (SC) through multiple PEGCs may be enabled.

Procedures to provide service continuity may be enabled, for example, if (e.g., when) more than one PEGC is selected by PEMC.

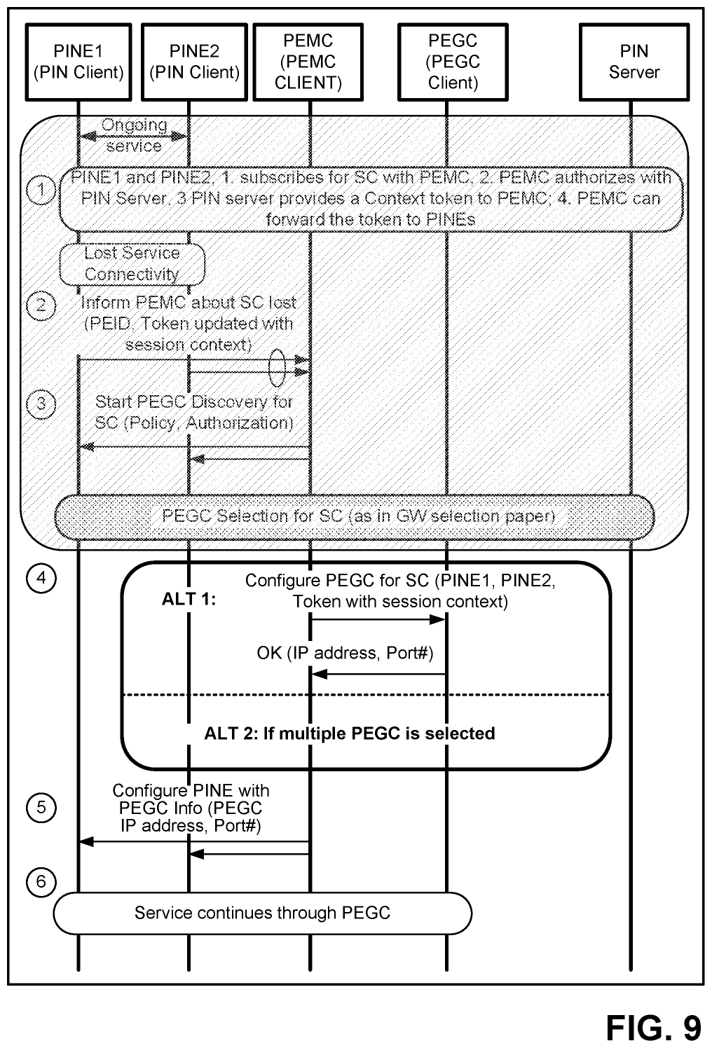

FIG. 9 illustrates an example procedure for service continuity. As shown in FIG. 9, service continuity may be provided if (e.g., when) multiple PEGCs are selected. As shown in FIG. 9, steps may be similar to the procedures described herein (e.g., with respect to FIG. 8). Procedures illustrated in FIG. 8 may be used (e.g., as shown in FIG. 9). The procedure (e.g., in FIG. 9) may be different the procedure illustrated in FIG. 8, for example, where (e.g., in FIG. 9) the Alternative 2 (ALT2) may be executed.

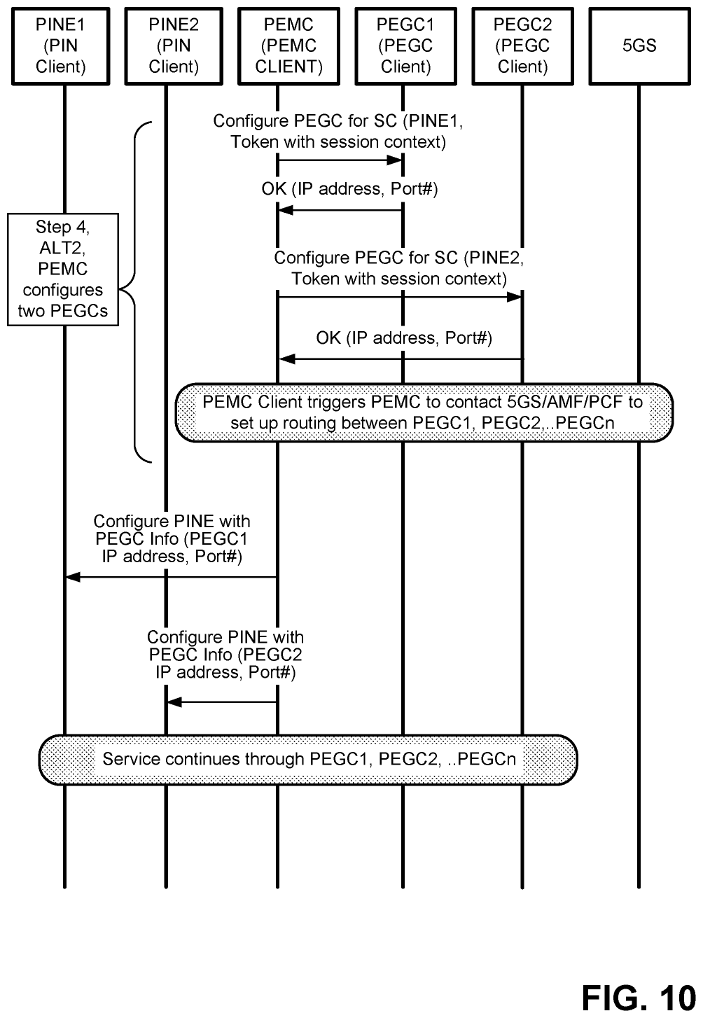

As shown in FIG. 9 at 940, ALT2 may include the following. The PINEs may discover a PEGC and may send PEGC information to the PEMC. The PEMC may not (e.g., not be able to) find a (e.g., single) PEGC which can serve the (e.g., two) PINEs. In that case, the PEMC may select multiple (e.g., two or more) PEGCs (e.g., optimal PEGCs) for service continuity, e.g., PEGC1 and PEGC2 (e.g., as shown in FIG. 10) that may provide a communication path for PINE1 and PINE2.

FIG. 10 illustrates an example procedure for service continuity.

The PEMC (e.g., the PIN Management Client) may configure (e.g., start configuring) the selected PEGCs (e.g., PEGC1 and PEGC2) for service continuity. The PEMC may decide that PEGC1 is to be used by PINE1 and PEGC2 is to be used by PINE2.

The PEMC may send a message (e.g., a selection message, such as, a Configure PEGC for SC message) to the selected PEGCs (e.g., PEGC1 and PEGC2). The message (e.g., selection message, such as, Configure PEGC for SC message) may include one or more of the following: a PINE ID 1 to PEGC1 and the context token; and/or a PINE ID 2 to PEGC2 and the context token.

The (e.g., each) PEGC (e.g., the PIN Gateway Client) may configure its forwarding tables, for example, so that the PINE traffic (e.g., PINE1 and PINE2), related to the service, may be forwarded properly. The PEGC may parse the context token, for example, to perform one or more of the following: to determine policy related to PINEs and allocate forwarding resources based on the policy; depending on the policy for the PINE, PEGC can use DHCP to assign a new address when the PINE connects, otherwise if supported by PEGC, PINEs IP address can be restored for seamless service continuity; to determine application context and set up forwarding path based on application state and application requirement; allocate port numbers for the (e.g., specific) session (e.g., possibly two for the two PINEs).

The PEGC (e.g., the PIN Gateway Client) may send a confirmation to PEMC (e.g., which includes PEGC IP address and Port numbers for the PINEs), for example, based on (e.g., after) successful configuration.

The PEMC (e.g., the PIN Management Client) can trigger another procedure, for example, by sending a (e.g., internal) message (e.g., Get pkt forwarding information for SC through PEGC (List of PEGC)) to the PEMC NAS layer, for example, if (e.g., when) the PEMC interacts with the system, such as 5GS (e.g., AMF, PCF), to obtain forwarding/routing rules between selected PEGCs (e.g., PEGC1, PEGC2, etc.). The system (e.g., 5GS) may send the forwarding rules to PEGC1 and PEGC2. PEGC Client 1 and PEGC Client 2 can update the forwarding table with the inter PEGC forwarding rules.

As shown in FIG. 9 at 950 the PIN Management Client in PEMC may instruct PIN Enabler Clients in PINE1 and 2 to connect to the selected PEGCs (PEGC1 and PEGC2) by sending a message (e.g., Configure PINE with PEGC Info message). The message (e.g., Configure PINE with PEGC Info message) may include one or more of the following: a PEGC1 Id, PEGC1 IP address, Port #created for PINE1; a PEGC2 Id, PEGC2 IP address, Port #created for PINE2; etc.

As shown in FIG. 9 at 960 the PIN Enabler Clients in PINE1 and PINE2 may set up (e.g., start setting up) the connection towards PEGC1 and PEGC2, for example, using the PEGC IP address, Port #, etc. The service between PINE1 and PINE2 continues through PEGC1 and PEGC2, for example, based on (e.g., after) successful setup.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1.-12. (canceled)

13. A wireless transmit/receive unit (WTRU) comprising:
a processor configured to:
receive a notification message, wherein the notification message indicates a loss of service continuity between a first personal Internet of Things network element (PINE) and a second PINE;
send a first discovery request message to the first PINE and second discovery request message to the second PINE, wherein the first discovery message and second discovery message indicate to initiate a PINE with gateway capability (PEGC) discovery;
receive a first discovery response message and a second discovery response message, wherein the first discovery response message indicates first PEGC discovery information from the first PINE, and wherein the second discovery response message indicates second PEGC discovery information from the second PINE;
determine a PEGC based on the first PEGC discovery information and the second PEGC discovery information;
send a selection and configuration message to the PEGC for service continuity between the first PINE and the second PINE;
receive a confirmation message from the PEGC indicating that service continuity between the first PINE and second PINE is configured; and
send a first configuration message to the first PINE and a second configuration message to the second PINE, wherein the first configuration message and second configuration message indicate service continuity configuration information.

14. The WTRU of claim 13, wherein the WTRU further comprises a PIN client.

15. The WTRU of claim 13, wherein the selection and configuration message is sent using a management function associated with the WTRU.

16. The WTRU of claim 13, wherein the selection and configuration message comprises first PINE information and second PINE information, wherein the first PINE information is associated with the first PINE, and wherein the second PINE information is associated with the second PINE.

17. The WTRU of claim 16, wherein the first PINE information indicates a first context token, and wherein the second PINE information indicates a second context token.

18. The WTRU of claim 13, wherein the confirmation message indicates the service continuity configuration information, wherein the service continuity configuration information indicates configuration information associated with the PEGC.

19. The WTRU of claim 13, wherein the first discovery message and second discovery message indicate PEGC information.

20. A method comprising:
receiving a notification message, wherein the notification message indicates a loss of service continuity between a first personal Internet of Things network element (PINE) and a second PINE;
sending a first discovery request message to the first PINE and second discovery request message to the second PINE, wherein the first discovery message and second discovery message indicate to initiate a PINE with gateway capability (PEGC) discovery;
receiving a first discovery response message and a second discovery response message, wherein the first discovery response message indicates first PEGC discovery information from the first PINE, and wherein the second discovery response message indicates second PEGC discovery information from the second PINE;
determining a PEGC based on the first PEGC discovery information and the second PEGC discovery information;
sending a selection and configuration message to the PEGC for service continuity between the first PINE and the second PINE;
receiving a confirmation message from the PEGC indicating that service continuity between the first PINE and second PINE is configured; and
sending a first configuration message to the first PINE and a second configuration message to the second PINE, wherein the first configuration message and second configuration message indicate service continuity configuration information.

21. The method of claim 20, wherein the method is performed by a PIN client.

22. The method of claim 20, wherein the selection and configuration message is sent using a management function associated with a wireless transmit/receive unit (WTRU).

23. The method of claim 20, wherein the selection and configuration message comprises first PINE information and second PINE information, wherein the first PINE information is associated with the first PINE, and wherein the second PINE information is associated with the second PINE.

24. The method of claim 23, wherein the first PINE information indicates a first context token, and wherein the second PINE information indicates a second context token.

25. The method of claim 20, wherein the confirmation message indicates the service continuity configuration information, wherein the service continuity configuration information indicates configuration information associated with the PEGC.

26. The method of claim 20, wherein the first discovery message and second discovery message indicate PEGC information.
